(19) United States
(12) Patent Application Publication
(10) Pub. No.: US 2012/0194332 A1
(43) Pub. Date: Aug. 2, 2012

(54) AUTOMOTIVE AUDIO LEVEL NOTIFIER

(76) Inventors: GANAPATHY LAKSHMANAPERUMAL, Peachtree City, GA (US); SHANTHA KUMARI RAJENDRAN, Peachtree City, GA (US)

(21) Appl. No.: 13/017,029

(22) Filed: Jan. 30, 2011

(51) Int. Cl. B60Q 1/00

(52) U.S. Cl. 340/438

(57) ABSTRACT

A system that notifies the automobile driver about excessive noise emitted out of the automobile audio system is provided. This is done to avoid a possible traffic law violation for excessive sound system noise. The system takes audio data from a microphone and calculates the decibel value based on it. The system also gets the current GPS coordinate location of the automobile and determines the state of country in which it is driven now. The current location is used by the system to determine the state legal limit of decibel value for automobile audio. If the current noise decibel level emitted from the automobile audio is greater than the state limit then the driver might be violating a state traffic law. The driver is alerted so that they can reduce the volume level.

### BACKGROUND OF THE INVENTION

We sometimes violate traffic laws which we are not aware of. One such law is related to excessive noise produced by automobile audio system. For example, Maine state driver hand book specifies that car sound system audible volume should not be more than 85 decibels. Decibel is a unit used to measure intensity of sound. When we are silent or speak softly the decibel level can be around 55. Normal volume in the car audio system can cause 70 decibels noise or so. It is very normal for people to increase the volume when their favorite song is on the radio or when there is a rocking music being played. This invention aims at giving awareness to the driver regarding the noise level produced by automobile stereo volume and about the possible violation of law.

### BRIEF SUMMARY OF THE INVENTION

This invention provides the automobile driver/passenger about the level of volume emitted out of the automobile's audio system. The system takes the audio value from a microphone and calculates decibels based on it. The system also gets the current GPS co-ordinate location of the automobile and determines the state of country in which it is driving now. The current location is used to determine the state's limit of decibel value for automobile audio. If the current decibel emitted from the automobile audio is greater than the state limit then the driver/passenger might be violating a state traffic law. This is notified to the driver/passenger so that the volume level can be reduced.

### DETAILED DESCRIPTION OF THE INVENTION

This invention aims at giving awareness to the driver regarding the noise level produced by their automotive stereo volume and about a possible violation of law.

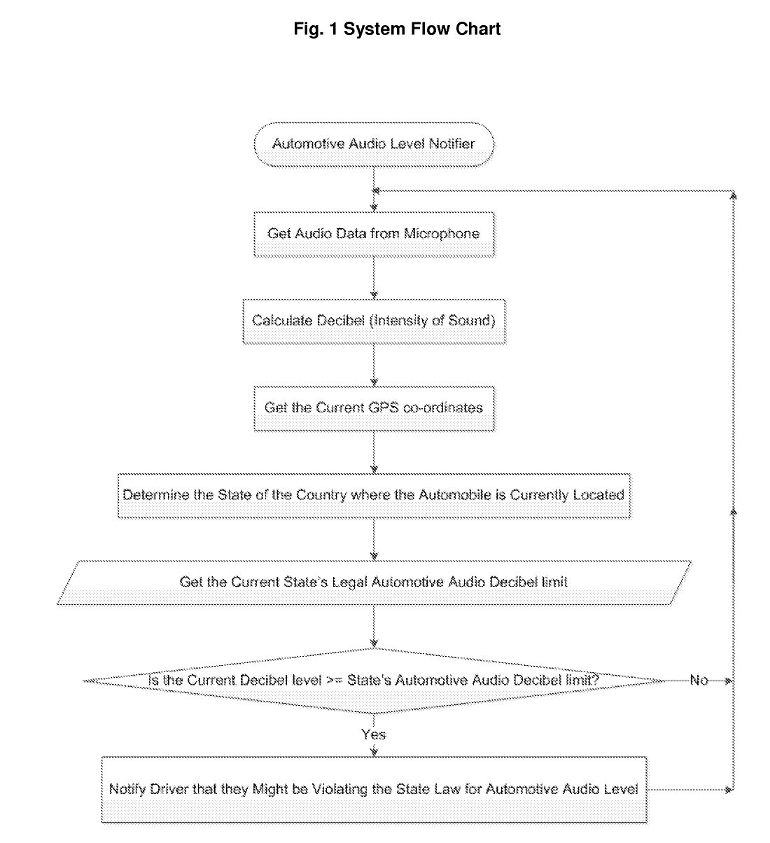

A microphone is used to feed the audio data to the invention. The audio data is used to calculate the decibel level of the audio. Filtered amplitude value of the audio data is used to derive the decibel value. Decibel is a unit used to measure intensity of sound. Flowchart in FIG. 1 shows processing of data done by the invention.

The system gets the GPS co-ordinate information. This is used to derive the current state in which the automobile is present. An internal database is present in the system which has all the states of the country and their corresponding automotive audio decibel traffic law limits.

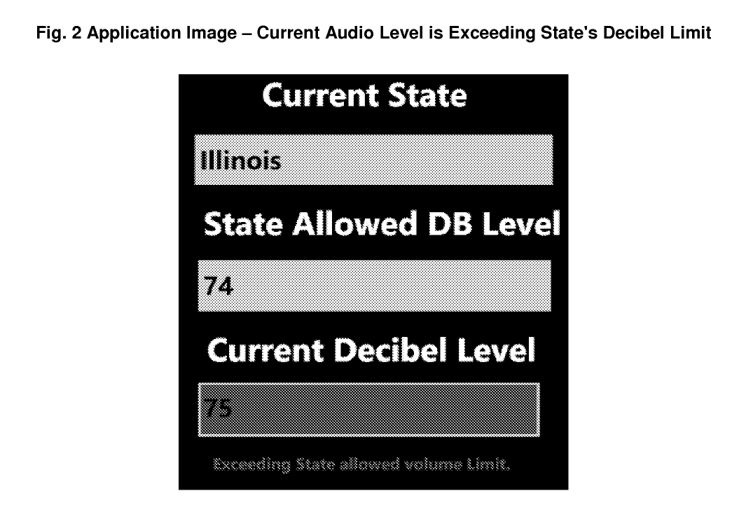

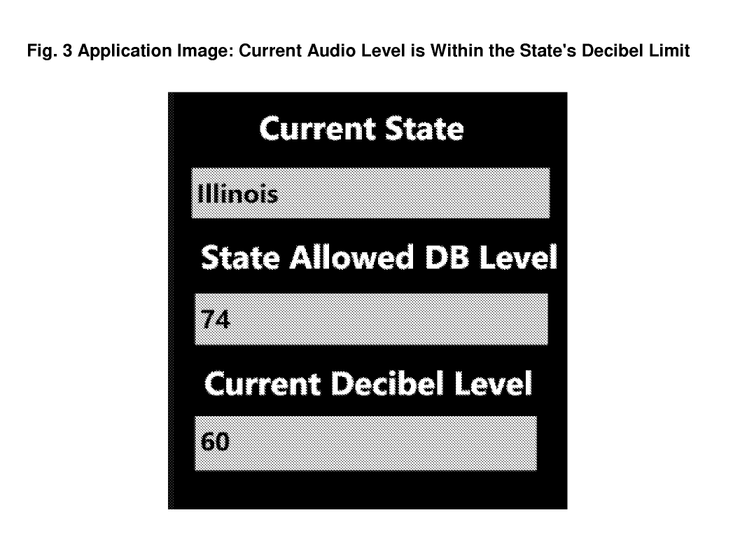

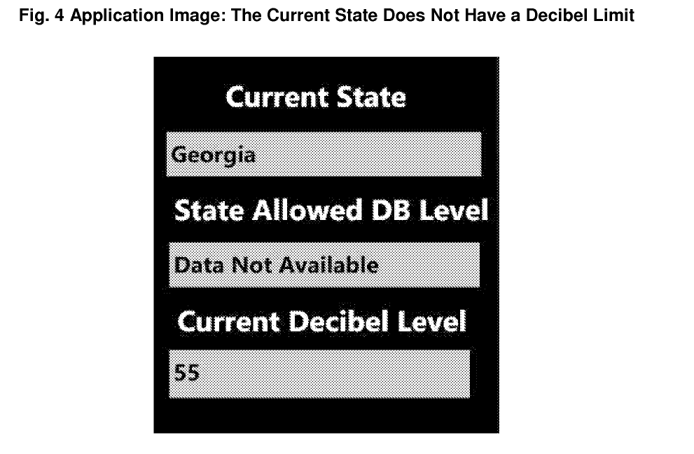

When the current audio decibel value is greater than the state limit, the driver/passenger is notified by a visual (text and color), audible and vibration alert to say that there might be a possible state traffic law violation. FIG. 2 shows how color and text is used in the application display to indicate a possible violation of state law. FIG. 3 shows the application display when there is no violation of state law. FIG. 4 shows the application display when the state does not have a law regarding loud auto audio systems.

Minimum requirement for this invention is an electronic control unit with microphone, GPS receiver, display device and speaker. The current implementation is done as a smartphone application.

1. A system to alert the driver regarding the noise level produced by automobile stereo volume and about the possible violation of law; wherein a microphone provides the audio data, global positioning system receiver provides the current state of the country; and decibel value is calculated based on the audio data; and an alert is triggered when the current decibel level is greater than the state's legal noise limit for automobile audio.

2. The system of claim 1, wherein filtered amplitude value of the audio data is used to calculate the decibel level.

3. The system of claim 1, wherein the global positioning system receiver's coordinate information is used to derive the current state of the country in which the automobile is present.

4. The system of claim 1, wherein an internal database is present which has all the states of the country and their corresponding automotive audio decibel traffic law limits.

5. The system of claim 1, wherein the driver is notified by color, text, audible and vibration alert to say that there might be a possible state traffic law violation when the current audio decibel value is greater than the state's limit.
